(19) United States
(12) Patent Application Publication
(10) Pub. No.: US 2013/0263813 A1
(43) Pub. Date: Oct. 10, 2013

(54) CYLINDER HEAD FOR AN INTERNAL COMBUSTION ENGINE

(71) Applicant: GE JENBACHER GMBH & CO OG, Jenbach (AT)

(72) Inventor: Marcel FOUQUET, Neustadt (DE)

(73) Assignee: GE Jenbacher GmbH & Co OG, Jenbach (AT)

(21) Appl. No.: 13/857,459

(22) Filed: Apr. 5, 2013

(30) Foreign Application Priority Data
Apr. 6, 2012 (AT) A 415/2012

(51) Int. Cl. F02F 1/24

(52) U.S. Cl. CPC F02F 1/24
USPC 123/193.5

(57) ABSTRACT

A cylinder head for an internal combustion engine, in particular a gas engine, comprising at least one main combustion chamber which is provided in the cylinder head and which extends to a combustion chamber opening in a cylinder head base of the cylinder head, wherein a pre-chamber is arranged in the cylinder head, wherein the at least one main combustion chamber is connected to the pre-chamber by way of at least one flow transfer passage.

The invention concerns a cylinder head for an internal combustion engine, in particular a gas engine, comprising at least one main combustion chamber which is provided in the cylinder head and which extends to a combustion chamber opening in a cylinder head base of the cylinder head.

Cylinder heads for internal combustion engines with main combustion chambers formed therein are already known. Thus U.S. Pat. No. 4,094,272 discloses a cylinder head for an internal combustion engine, wherein a main combustion chamber is formed beneath an exhaust valve. In conjunction with a flow passage in the cylinder head base, during compression in the compression cycle of the internal combustion engine, corresponding turbulence or swirl phenomena occur in the main combustion chamber, which have an advantageous effect on the combustion characteristics.

Modern internal combustion engines, in particular high-power gas engines involving large combustion chamber volumes are frequently operated with over-stoichiometric combustion air ratio, to reduce the emissions of nitrogen oxides. In that case the fuel-air mixture in the main combustion chamber has a very high air excess. In order to efficiently ignite such a lean fuel-air mixture a correspondingly high degree of ignition energy is required.

The object of the invention is to provide a cylinder head which is improved over the state of the art. In particular the invention seeks to provide that the cylinder head is suitable for being operated with very lean fuel-air mixtures, with a relatively great air excess.

According to the invention that object is attained in that a pre-chamber is arranged in the cylinder head, wherein the at least one main combustion chamber is connected to the pre-chamber by way of at least one flow transfer passage.

In the case of internal combustion engines which are operated on the Otto cycle, in particular in the case of stationary gas engines in which a fuel gas-air mixture is fired, the lean concept is used in relation to relatively large combustion chamber volumes. This means that there is a relatively great air excess, whereby with maximum power density and at the same time a high level of efficiency of the engine, the pollutant emission and the thermal loading on the components are kept as low as possible. Ignition and combustion of very lean fuel-air mixtures represents in that respect a considerable challenge in terms of development and operation of modern high-power gas engines.

With the proposed cylinder head, a pre-chamber which is divided off from the main combustion chamber is used as an ignition booster, the fuel-air mixture which is highly compressed at the end of the compression stroke being fired in the pre-chamber. The pre-chamber is in communication with the main combustion chamber by way of a flow transfer passage, by way of which ignition flares can penetrate from the fired pre-chamber into the main combustion chamber and can efficiently ignite the fuel-air mixture therein. For ignition in the pre-chamber, a fuel-air mixture which is richer in comparison with the main combustion chamber is usually provided in the pre-chamber. Thus the fuel-air mixture in the pre-chamber can have for example a combustion air ratio of between about 0.8 and 0.9 whereas the lean fuel-air mixture in the main combustion chamber can have a combustion air ratio λ of between about 1.9 and 2.0. In that case ignition in the pre-chamber can be effected by an electrode spark plug, a laser spark plug or also for example by corona ignition. Due to the comparatively rich fuel-air mixture in the pre-chamber, optimum ignition conditions are afforded and by virtue of the energy density this gives intensive ignition flares which issue into the main combustion chamber and lead to rapid firing through the lean fuel-air mixture in the main combustion chamber.

The proposed cylinder head is suitable in particular for internal combustion engines or gas engines of large swept volumes. The main combustion chamber can be kept comparatively short and compact, by virtue of the formation of the main combustion chamber in the cylinder head. The pre-chamber which is also provided in the cylinder head provides that ignition flares can be introduced into that compact main combustion chamber over flame paths which are as short as possible, can produce thorough ignition therein, and can permit rapid combustion.

In conventional internal combustion engines equipped with a pre-chamber the pre-chamber or a cap thereof usually projects centrally between the valves out of the fire plate or the cylinder head base into the main combustion chamber. The bores required for that purpose in the cylinder head base mean that the latter is structurally correspondingly weakened. In addition the pre-chamber cap is thermally particularly highly loaded. That can lead to increased wear and unwanted incandescence ignition phenomena.

In a proposed cylinder head the pre-chamber can be accommodated entirely in the cylinder head so that this does not involve any structural weakening of the cylinder head base or fire plate. In particular it is possible to avoid a pre-chamber cap projecting into the main combustion chamber. In addition it is easily possible in that way to provide cooling devices in the cylinder head, which are arranged in the region of the pre-chamber and/or the main combustion chamber and permit efficient cooling without weakening the structure of the cylinder head or the cylinder head base.

In a preferred embodiment it can be provided that the at least one main combustion chamber can be delimited by an exhaust valve arranged in the cylinder head.

Preferably it can be provided that the at least one main combustion chamber has an inside wall which is preferably at least region-wise of a substantially hemispherical configuration. The combustion chamber opening can therefore preferably be of a substantially circular or elliptical configuration.

To permit particularly short flame paths a region of the inside wall can be formed by a surface of the pre-chamber.

A particular variant provides that a depth of the main combustion chamber in relation to the combustion chamber opening is less than half a diameter of the combustion chamber opening.

To make it possible for a plurality of ignition flares to be introduced into the main combustion chamber from the pre-chamber, alternatively or additionally to a plurality of flow transfer passages it can be provided that at least one flow transfer bore and preferably a plurality of flow transfer bores is/are provided at an end of a flow transfer passage, wherein the at least one flow transfer bore opens into the at least one main combustion chamber.

A particularly advantageous embodiment of the invention is that in which provided in the cylinder head base is a flow passage in the form of a recess, wherein the flow passage connects a valve seat of an inlet valve to the main combustion chamber. In that case the flow passage can open into a recess of the valve seat which is usually substantially in the form of a circular ring, wherein that recess of the valve seat extends along a peripheral region of the valve seat, preferably in the region of between about 10% and about 35% of the periphery of the valve seat. It is particularly desirable in that respect if the flow passage opens into the main combustion chamber off-center, preferably substantially tangentially in relation to an inside wall of the main combustion chamber. By virtue of such a flow passage, during the compression stroke, corresponding turbulence or swirl phenomena can be produced in the main combustion chamber. Particularly if the flow passage opens into the main combustion chamber substantially tangentially in relation to the inside wall of the main combustion chamber, advantageous swirl effects can be produced about an upright axis which for example can be coincident with the axis of the exhaust valve. The swirl or turbulence phenomena produced in that way provide for even faster and thus more efficient burning of the fuel-air mixture in the main combustion chamber. That is advantageous in particular in operation with a very lean fuel-air mixture as, with increasing leanness, the ignitability of the mixture falls and thus combustion is worsened. Measures for increasing turbulence lead to higher flow speeds and thus improve combustion in the main combustion chamber.

In a particularly preferably configuration it can be provided that at least one cooling device is arranged in the cylinder head, preferably in the region between the cylinder head base and the pre-chamber and/or in the region of the main combustion chamber. The thermal loading can be correspondingly reduced by the provision of cooling in the region of the pre-chamber and/or in the region of the main combustion chamber. In addition the provision of the pre-chamber in the cylinder head means that it is possible to avoid a cap of the pre-chamber projecting into the main combustion chamber and causing incandescence ignition phenomena there.

In general it can also be provided that the cylinder head has a plurality of main combustion chambers and a plurality of flow transfer passages, wherein a respective main combustion chamber is connected to the pre-chamber by way of at least one respective flow transfer passage, wherein preferably the plurality of flow transfer passages are of substantially the same length. In addition generally the diameter of the flow transfer passages and/or the flow transfer bores as well as the direction of the transfer flow passages and/or the flow transfer bores can be adapted in relation to a main combustion chamber in accordance with the desired depth of penetration and orientation of the ignition flares.

Protection is also sought for an internal combustion engine, in particular a stationary gas engine, having at least one cylinder head. Preferably it can be provided in that respect that the cylinder head is arranged at a cylinder with a piston movable therein, wherein a piston position at the top dead center point of the piston defines a compression volume of the cylinder, wherein the main combustion chamber, preferably jointly with an optionally provided flow passage, forms between about 70% and 95% of the compression volume. In a preferred embodiment it can be provided that the pre-chamber forms less than 5%, preferably between about 1% and 2%, of the compression volume.

A proposed internal combustion engine can be operated in accordance with the Miller cycle process known in the state of the art. When applying the Miller control times geometrical compression can be advantageously increased, without increasing the compression pressure.

To allow early opening of the inlet valve with a high geometrical compression ratio at least one recess and/or at least one depression (so-called valve pockets) can be provided in a surface of the piston, that faces towards the cylinder head.

In this connection a particular variant provides that a swept volume is defined by the piston movable in the cylinder, wherein the compression ratio which corresponds to the sum of the swept volume and the compression volume in relation to the compression volume is between about 12.5 and about 16.

Further details and advantages of the present invention are described by means of the specific description hereinafter. In the drawing:

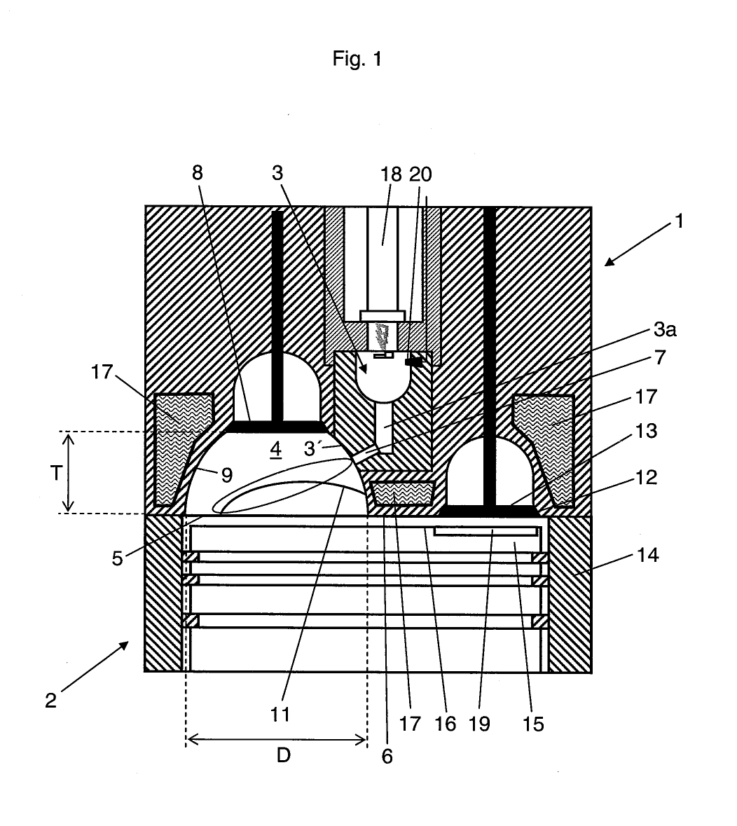

FIG. 1 shows a cross-section through a proposed cylinder head arranged at a cylinder of an internal combustion engine,

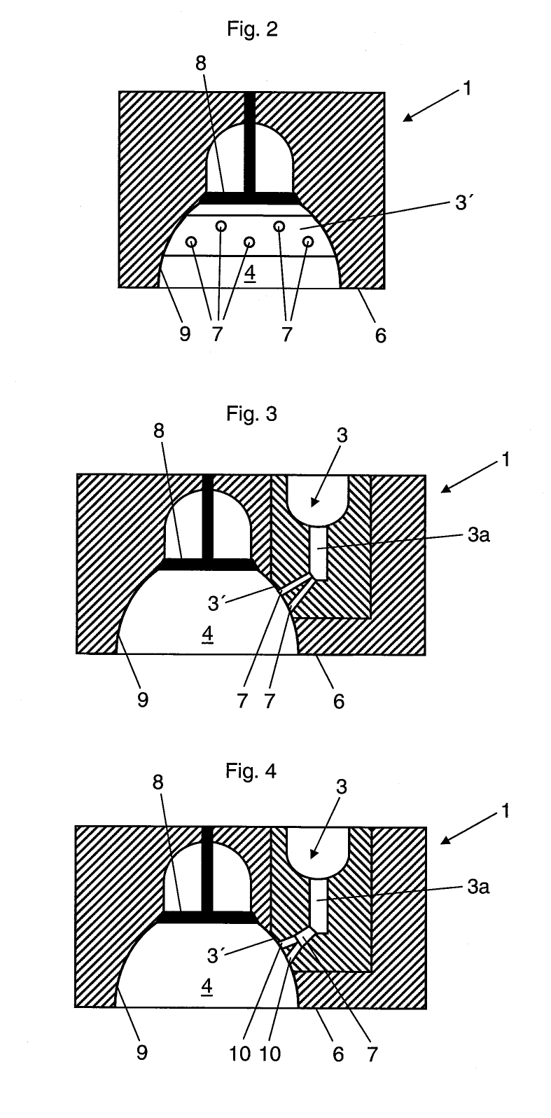

FIG. 2 shows a cross-section through the main combustion chamber of a proposed cylinder head,

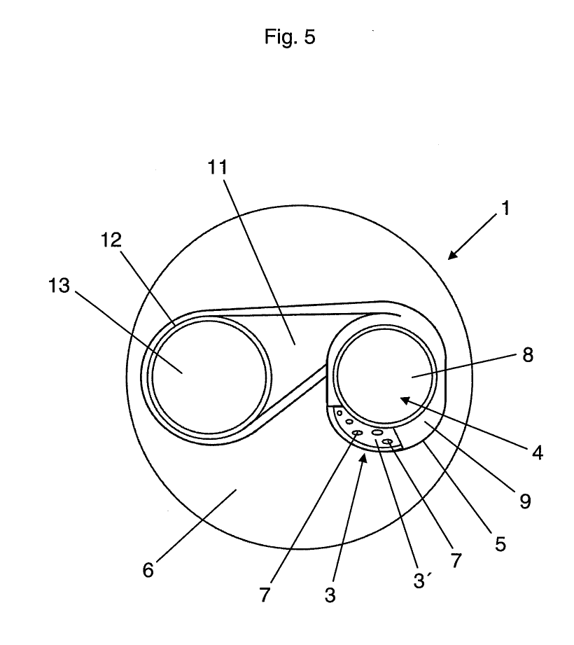

FIGS. 3 and 4 show cross-sectional views of further variants of a proposed cylinder head, and

FIG. 5 shows a view from below of a proposed cylinder head.

FIG. 1 shows a cross-section through a proposed cylinder head 1 arranged at a cylinder 14 of an internal combustion engine 2 with piston 15 movable therein. Provided in the cylinder head 1 is a main combustion chamber 4 having a substantially hemispherical inside wall 9. In this view the main combustion chamber 4 is delimited upwardly by the valve head of an exhaust valve 8 and downwardly the main combustion chamber 4 opens by way of a combustion chamber opening 5 which is of a substantially circular round configuration in this example into an internal space in the cylinder 14. A piston 15 moves up and down within the cylinder 14 in known manner, wherein, when the top dead center point of the piston 15 is reached, a surface 16 of the piston 15 is at an only very small spacing relative to the cylinder head base 6 of the cylinder head 1 or the valve head of an inlet valve 13 arranged in the cylinder head 1. That small spacing however is sufficient to open the inlet valve 13 for an induction cycle. For that purpose valve pockets or recesses 19 can be provided in the piston surface 16 of the piston 15.

In this example the depth T of the main combustion chamber 4 in relation to the combustion chamber opening or a notional plane of the cylinder head base 6 is less than half the diameter D of the combustion chamber opening 5.

A pre-chamber 3 is arranged in the cylinder head 1. The pre-chamber 3 has an outer surface 3′ forming a region of the inside wall 9 of the main combustion chamber 4. The pre-chamber 3 includes a pre-chamber neck 3a of a substantially rotationally symmetrical configuration. One or more flow transfer passages 7 connects or connect the main combustion chamber 4 and the pre-chamber 3 or its pre-chamber neck 3a so that, by virtue of ignition of a fuel-air mixture in the pre-chamber 3, ignition flares can penetrate into the main combustion chamber 4 by way of the flow transfer passage or passages 7 and can ignite a fuel-air mixture in the main combustion chamber 4. The pre-chamber 3 is provided with an ignition device to ignite the fuel-air mixture in the pre-chamber 3. In that respect it is advantageous if the ignition device—as in the illustrated example—is arranged substantially opposite the at least one flow transfer passage 7 in the pre-chamber 3. In the illustrated example ignition of the fuel-air mixture in the pre-chamber 3 is effected by an electrode spark plug 18.

Provided in the cylinder head 1 in the region of the main combustion chamber 4 and the pre-chamber 3 are a plurality of cooling devices 17 in the form of cooling passages through which can flow a cooling agent, for example water. Advantageous cooling of the pre-chamber 3 and the main combustion chamber 4 is effected by the cooling devices 17.

In this example a flow passage 11 in the form of a recess is provided at the cylinder head base 6. That flow passage 11 connects the valve seat 12 of the inlet valve 13 arranged in the cylinder head 1 to the main combustion chamber 4. The depth of that recess or flow passage 11 in relation to the otherwise substantially flat cylinder head base 6 increases in that case in the direction of the main combustion chamber 4. In conjunction with a configuration of the flow passage 11 such that it opens into the main combustion chamber 4 substantially tangentially in relation to the inside wall 9 of the main combustion chamber 4, this gives advantageous turbulence or swirl phenomena for a fuel-air mixture flowing into the main combustion chamber 4, during a compression stroke. Swirl phenomena which are made possible in that way about an upright axis of the main combustion chamber 4 can achieve still faster and thus more efficient combustion of the fuel-air mixture.

The introduction of fuel or a fuel-air mixture into the at least one main combustion chamber 4 and the at least one pre-chamber 3 can be effected by devices known in the state of the art. Thus fuel or a fuel-air mixture can be introduced into the main combustion chamber 4 by way of the inlet valve 13 arranged in an inlet tract of the cylinder head 1. During the compression stroke a part of the fuel-air mixture disposed in the at least one main combustion chamber 4 flows in known manner into the pre-chamber 3 by way of the at least one flow transfer passage 7. To enrich the fuel-air mixture disposed in the pre-chamber 3, additional fuel can be introduced into the pre-chamber 3 by way of a suitable fuel metering device 20 known in the state of the art (for example in the form of a pre-chamber gas valve). In that respect it is advantageous if the combustion air ratio of the fuel-air mixture in the pre-chamber 3 is lower than the combustion air ratio of the fuel-air mixture in the at least one main combustion chamber 4. It is particularly advantageous if the combustion air ratio of the fuel-air mixture in the at least one main combustion chamber 4 is greater than 1.8, preferably between about 1.9 and about 2.2, particularly preferably between about 1.9 and about 2.0, and if the combustion air ratio of the fuel-air mixture in the pre-chamber 3 is less than 1, preferably between about 0.6 and about 0.9, particularly preferably between about 0.8 and about 0.9.

FIG. 2 shows a sectional view through a proposed cylinder head 1 viewing in a direction from the main combustion chamber 4 on to a surface 3′ of the pre-chamber 3, the surface 3′ forming a part of the inside wall 9 of the main combustion chamber 4. This view clearly shows a plurality of flow transfer passages 7 which respectively connect the main combustion chamber 4 to the pre-chamber 3. It is possible in that way to establish the number and orientations of the ignition flares passing into the main combustion chamber 4.

FIG. 3 shows a further sectional view through a part of a proposed cylinder head 1 similar to FIG. 1. This also shows a plurality of flow transfer passages 7 which respectively connect the main combustion chamber 4 to the pre-chamber 3 or the pre-chamber neck 3a thereof. The sum of all cross-sectional areas of the flow transfer passages 7 which open from the pre-chamber neck 3a into the main combustion chamber 4 can in this case be substantially equal to the cross-sectional area of the pre-chamber neck 3a.

FIG. 4 shows a further embodiment of a proposed cylinder head 1 in a view as shown in FIG. 3. This view shows a flow transfer passage 7 connecting the main combustion chamber 4 to the pre-chamber 3 or its pre-chamber neck 3a. In this case, provided at the end of the illustrated flow transfer passage 7, that is towards the main combustion chamber 4, are two flow transfer bores 10 which each open into the main combustion chamber 4. In that way, alternatively or additionally to the provision of a plurality of flow transfer passages 7, it is also possible to establish the number and orientations of the ignition flares passing into the main combustion chamber 4. In general thread branchings can be formed with such a configuration of an end of a flow transfer passage 7 by the flow transfer bores 10.

FIG. 5 shows a view from below on to a proposed cylinder head 1 viewing on to the cylinder head base 6 of the cylinder head 1. Formed in the cylinder head 1 is a main combustion chamber 4 having a substantially elliptical combustion chamber opening 5 at the cylinder head base 6. At the end opposite to the combustion chamber opening 5 the main combustion chamber 4 is delimited by an exhaust valve 8. A part of the inside wall 9 of the main combustion chamber 4 is formed by a surface 3′ of a pre-chamber 3 arranged in the cylinder head 1. A plurality of flow transfer passages 7 open from the pre-chamber 3 (not shown in greater detail here) into the main combustion chamber 4 by way of the surface 3′ of the pre-chamber 3. Formed in the cylinder head base 6 is a flow passage 11 in the form of a recess, the flow passage 11 connecting a valve seat 12 of an inlet valve 13 to the main combustion chamber 4. The flow passage 11 opens substantially tangentially in relation to the inside wall 9 into the main combustion chamber 4 and the depth of the flow passage 11 in relation to the cylinder base 6 increases in the direction of the main combustion chamber 4. In that way, it is possible to achieve turbulence and swirl phenomena which are advantageous for thorough ignition in the main combustion chamber 4, of a fuel-air mixture which flows into the main combustion chamber 4 during the compression stroke.

1. A cylinder head for an internal combustion engine, in particular a gas engine, comprising at least one main combustion chamber which is provided in the cylinder head and which extends to a combustion chamber opening in a cylinder head base of the cylinder head, wherein a pre-chamber is arranged in the cylinder head, wherein the at least one main combustion chamber is connected to the pre-chamber by way of at least one flow transfer passage.

2. A cylinder head as set forth in claim 1, wherein the pre-chamber is equipped with an ignition device, with an electrode spark plug or a laser spark plug, wherein the ignition device is arranged substantially opposite the at least one flow transfer passage in the pre-chamber.

3. A cylinder head as set forth in claim 1, wherein that a fuel-air mixture disposed in the at least one main combustion chamber can be ignited by ignition flares issuing from the at least one flow transfer passage.

4. A cylinder head as set forth in claim 3, wherein the fuel-air mixture disposed in the at least one main combustion chamber has an over-stoichiometric combustion air ratio, wherein the combustion air ratio of the fuel-air mixture in the at least one main combustion chamber is greater than 1.8.

5. A cylinder head as set forth in claim 3, wherein the combustion air ratio of a fuel-air mixture in the pre-chamber is lower than the combustion air ratio of the fuel-air mixture in the at least one main combustion chamber, wherein the combustion air ratio of the fuel-air mixture in the pre-chamber is less than 1.

6. A cylinder head as set forth in claim 1, wherein the at least one main combustion chamber can be delimited by an exhaust valve arranged in the cylinder head.

7. A cylinder head as set forth in claim 1, wherein the at least one main combustion chamber has an inside wall which is at least region-wise of a substantially hemispherical configuration.

8. A cylinder head as set forth in claim 7, wherein a region of the inside wall is formed by a surface of the pre-chamber.

9. A cylinder head as set forth in claim 1, wherein the combustion chamber opening is of a substantially circular or elliptical configuration.

10. A cylinder head as set forth in claim 1, wherein a depth of the main combustion chamber in relation to the combustion chamber opening is less than half a diameter of the combustion chamber opening.

11. A cylinder head as set forth in claim 1, wherein at least one flow transfer bore and a plurality of flow transfer bores are provided at an end of the flow transfer passage, wherein the at least one flow transfer bore opens into the at least one main combustion chamber.

12. A cylinder head as set forth in claim 1, wherein provided in the cylinder head base is a flow passage in the form of a recess, wherein the flow passage connects a valve seat of an inlet valve to the main combustion chamber.

13. A cylinder head as set forth in claim 12, wherein the flow passage opens into the main combustion chamber off-center, substantially tangentially in relation to an inside wall of the main combustion chamber.

14. A cylinder head as set forth in claim 1, wherein at least one cooling device is arranged in the cylinder head in the region between the cylinder head base and the pre-chamber and/or in the region of the main combustion chamber.

15. A cylinder head as set forth in claim 1, wherein the cylinder head has a plurality of main combustion chambers and a plurality of flow transfer passages, wherein a respective main combustion chamber is connected to the pre-chamber by way of at least one respective flow transfer passage.

16. An internal combustion engine, in particular a stationary gas engine, comprising at least one cylinder head as set forth in claim 1.

17. An internal combustion engine as set forth in claim 16, wherein the cylinder head is arranged at a cylinder with a piston movable therein, wherein a piston position at the top dead center point of the piston defines a compression volume of the cylinder, wherein the main combustion chamber, jointly with an optionally provided flow passage, forms between about 70% and 95% of the compression volume.

18. An internal combustion engine as set forth in claim 17, wherein the pre-chamber forms less than 5%, of the compression volume.

19. An internal combustion engine as set forth in claim 16 wherein at least one of a group consisting of a recess and a depression is provided in a surface of the piston, the surface facing towards the cylinder head.

20. An internal combustion engine as set forth in claim 16 wherein a swept volume is defined by the piston movable in the cylinder, wherein the compression ratio which corresponds to the sum of the swept volume and the compression volume in relation to the compression volume is between about 12.5 and about 16.

21. A cylinder head as set forth in claim 4, wherein the combustion air ratio of the fuel-air mixture in the at least one main combustion chamber is between about 1.9 and about 2.2.

22. A cylinder head as set forth in claim 21, wherein the combustion air ratio of the fuel-air mixture in the at least one main combustion chamber is between about 1.9 and about 2.0.

23. A cylinder head as set forth in claim 5, wherein the combustion air ratio of the fuel-air mixture in the pre-chamber is between about 0.6 and about 0.9.

24. A cylinder head as set forth in claim 23, wherein the combustion air ratio of the fuel-air mixture in the pre-chamber is between about 0.8 and about 0.9.
